(19) United States
(12) Patent Application Publication
(10) Pub. No.: US 2023/0039360 A1
(43) Pub. Date: Feb. 9, 2023

(54) DEVICE AND METHOD FOR THREE-DIMENSIONAL SOUND REPRODUCTION

(71) Applicant: Alessandro VERDOLIVA, Rome (IT)

(72) Inventor: Alessandro VERDOLIVA, Rome (IT)

(21) Appl. No.: 17/794,685

(22) PCT Filed: Feb. 8, 2021
(86) PCT No.: PCT/IB2021/050988

§ 371 Date: Jul. 22, 2022

(30) Foreign Application Priority Data
Mar. 12, 2020 (IT) 102020000005299

(51) Int. Cl. H04S 7/00; H04R 5/033; H04R 5/04; H04R 1/10

(52) U.S. Cl. CPC H04S 7/304; H04R 5/033; H04R 5/04; H04R 1/1008; H04R 1/1075; H04S 2400/11

(57) ABSTRACT

Described is a device for the reproduction of three-dimensional sound, in particular headphones, including a pair of specular pads, having a shape such as to substantially form a portion of geoid or a hemisphere where each pad defines a concave inner surface having a plurality of recesses distributed according to a predetermined distribution. The device includes a plurality of loudspeakers, designed for sound reproduction and housed in these recesses. The device also includes a control unit, connected to the plurality of loudspeakers, configured to perform an analysis of a digital sound source and to determine a sound reproduction configuration of the loudspeakers as a function of the analysis of the sound source.

This invention relates to the technical field of the reproduction of digital sound sources and finds particular use in applications such as virtual reality, augmented reality and videogames.

The invention also relates to the sound reproduction of professional audio formats.

More specifically, the invention relates to a three-dimensional sound reproduction device and method.

In these sectors, it is extremely important to be able to guarantee a good quality of the sound as well as good directionality in such a way as to provide complete sensorial immersion in the virtual environment.

In other words, sound reproduction devices must be capable of simulating as faithfully as possible how the human ear perceives the surrounding sounds.

For this purpose, a widespread technique is Binaural recording and reproduction whose purpose is to obtain a sound as close as possible to that which is perceived by the hearing apparatus.

A very important parameter concerns the directional accuracy of sound. In other words, a very important parameter concerns the ability to distinguish the direction of origin of a sound. The parameter is reproduced by the devices by simulating two separate effects.

The first effect, indicated by the acronym ITD, that is, the “Interaural Time Difference”, concerns the difference between the arrival times of the sound wave at the eardrum of the listener.

In other words, the ear closest to the source will collect the sound in advance whilst the ear positioned in the “shadow zone”, that is to say, in the area screened by the skull which obstructs the propagation of the sound wave, will receive the sound with a delay proportional to the orientation of the head relative to the sound source.

The second effect, indicated by the acronym ILT, that is, the “Interaural Level Difference”, concerns the difference in the arrival intensity of the sound.

In other words, the ear closest to the source will receive the sound with greater intensity whilst the ear furthest away, located in the shadow zone, will receive the sound with less intensity.

IDL and ILT tend to cancel each other out when the listener is oriented in the direction of the sound source.

Thanks to these effects, the human ear can perceive more or less exactly the direction in which the sound source is operated according to the orientation of the head.

It follows that, by simulating these effects, the devices are able to reproduce a three-dimensionality of the sounds.

In particular, the devices simulate the first effect reproducing the sound in the ear considered in the shadow area with a certain delay whilst simulating the second effect by panning techniques, that is to say, reproducing the sound in the ear considered in a shadow area with a lesser intensity and varying the intensity according to any changes in orientation.

Another parameter which is taken into consideration is how our body, and in particular the skull, change the sound waves before they reach the eardrums.

This effect is taken into account through the HRTF, that is, the “Head Related Transfer Function”, defined as the function of transfer of the skull.

In nature, these modifications are caused by the shape of the head, and in particular by the shape of the ears. In other words, each “obstacle” encountered will unperceivably modify the sound, varying frequencies and phases. Therefore, depending on origin, the sound meets different acoustic modifications.

The prior art devices are equipped with software which, depending on different models, are capable of simulating this effect by processing the sound source in such a way as to reproduce the equalisations which would be performed by the ears.

At a structural level, prior art devices comprise headphones having a total number of loudspeakers which vary from 2 to a maximum of 12 loudspeakers, equally distributed in the two pads, where the pads have a substantially planar shape, adhering to the wearer's ear.

These solutions have various drawbacks and limitations.

In particular, the prior art devices substantially have two problems: the low number of loudspeakers and the shape of the pads.

In particular, the number of loudspeakers is too low to be able to simultaneously express good directional accuracy and good sound quality.

Moreover, again due to the low number of loudspeakers to be used to reproduce the sounds, the membranes of the loudspeakers are stressed excessively and are not able to express the frequencies of the sound waves in a correct manner, further adversely affecting the quality of the sound. This drawback is made even more evident in the presence of a large number of sounds to be reproduced.

With regard to the pads, their shape is insufficient to guarantee a correct propagation of the sound waves which are reproduced by the loudspeakers, in particular due to the reduced distance between loudspeakers and eardrum and due to the arrangement, which is typically vertical.

Lastly, another problem is the orientation of the loudspeakers with respect to the eardrums. More specifically, the loudspeakers are substantially oriented transversely to the pad and typically all in the same direction.

As a result, the propagation of the sound waves is not optimised.

In this context, the aim of the invention is therefore to meet the above-mentioned needs, and in particular an aim of the invention is to provide a three-dimensional sound reproduction device and method which is able to reproduce the audio in the most faithful manner possible to the way in which a sound wave propagates and changes according to the effects of incidence on the skull of the individual.

In particular, the aim of the invention is to provide a three-dimensional sound reproduction device and method which allows optimisation of directional accuracy and sound quality.

These and other aims which will become more apparent in the description below are substantially achieved by a three-dimensional sound reproduction device and method according to the invention.

The device for three-dimension sound reproduction, in particular headphones, comprises a pair of specular pads having a shape such as to substantially form a portion of geoid or a hemisphere where each pad defines a concave inner surface having a plurality of recesses distributed according to a predetermined distribution.

The device also comprises a plurality of loudspeakers, suitable for sound reproduction and housed in the recesses of the pads. The device also comprises a control unit, connected to the plurality of loudspeakers and configured to perform an analysis of a digital sound source and to determine a sound reproduction configuration of the loudspeakers as a function of the analysis of the sound source.

The three-dimensional sound reproduction method comprises preparing a digital sound source defined by a graphical motor or a professional audio format and a three-dimensional sound reproduction device. The reproduction device analyses the sound source as a function of the virtual position and orientation parameters of the device relative to the sound source.

A reproduction configuration of the loudspeakers is selected as a function of the analysis and the sound source is reproduced by means of that reproduction configuration.

Further features of the invention are more apparent from the following detailed description of preferred, but not exclusive embodiments of the device.

The device is described below with reference to the accompanying drawings which are provided solely for the purpose of a non-limiting example, in which:

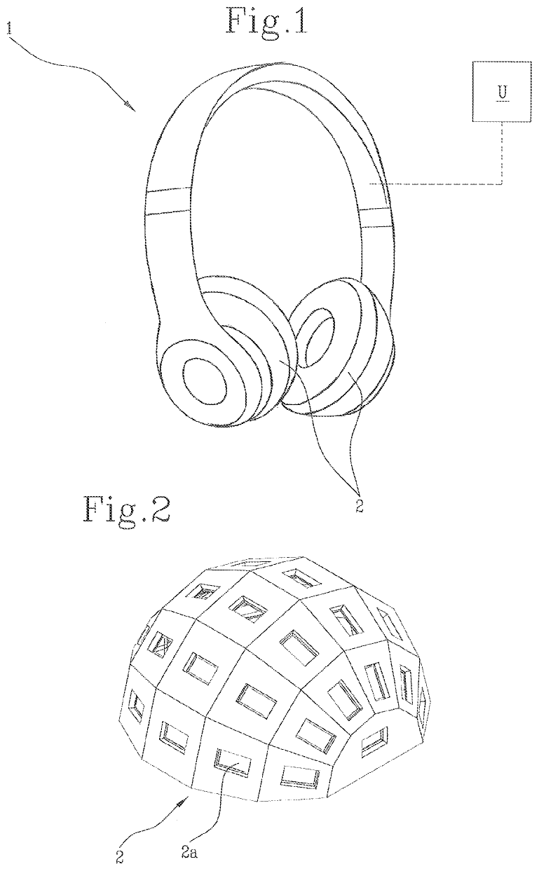

FIG. 1 is a schematic representation of a sound reproduction device according to the invention;

FIG. 2 is a perspective view of an embodiment of a detail of the device of FIG. 1;

FIG. 3 is a perspective view of a further embodiment of a detail of the device of FIG. 1;

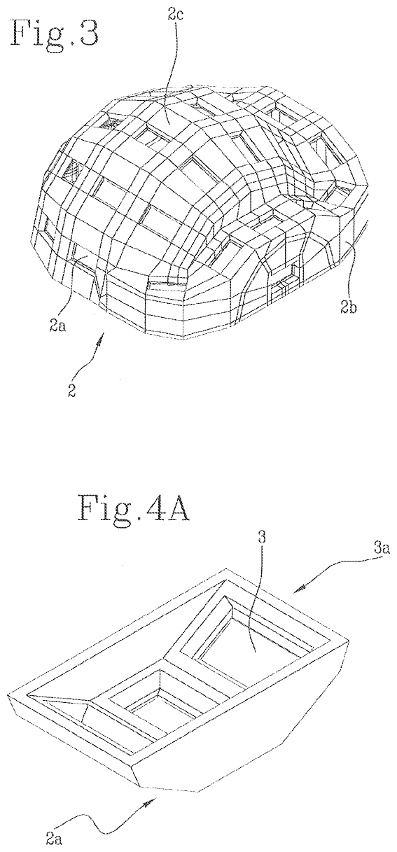

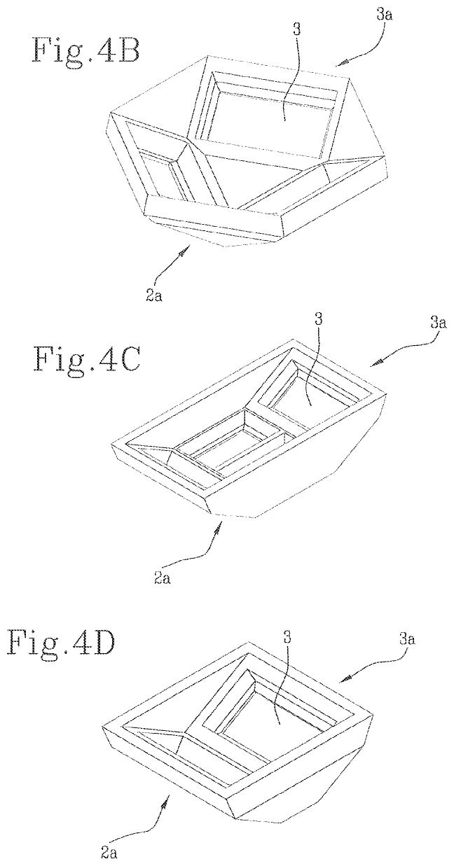

FIGS. 4a-4d are schematic views of different embodiments of a detail of the device of FIG. 1;

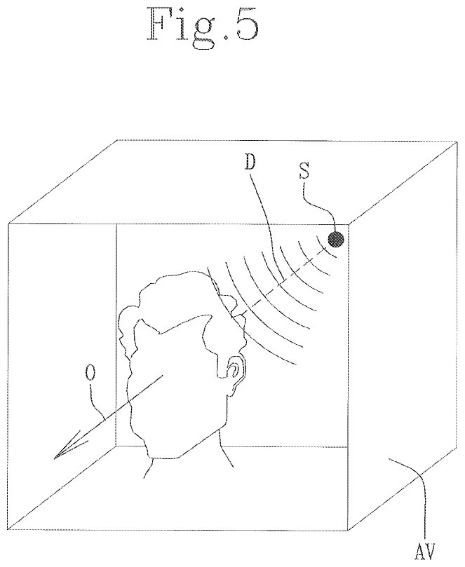

FIG. 5 shows an example view of a virtual environment.

With reference to the accompanying drawings, the numeral 1 denotes in its entirety a device 1 for three-dimensional sound reproduction according to the invention.

According to a preferred embodiment, the device 1 is made in the form of headphones.

However, there are further embodiments wherein the device 1 can be made as a headset which is applied in particular in virtual reality, improved realty and/or videogames.

Basically, the device 1 comprises a pair of specular domes 2, a plurality of loudspeakers 3 installed in the pads 2 and a control unit “U”, connected to the plurality of loudspeakers 3, configured to perform an analysis of a digital sound source “S” and to determine a sound reproduction configuration of the loudspeakers 3 as a function of the analysis of the sound source “S”.

The term control unit “U” may mean a driver, that is to say, a software installed in the device 1 and in a PC or in a console.

For this reason, the control unit “U” may be understood either as a component integrated in the device 1, or other platform, as well as a software element. The control unit “U” may also be considered as a hardware part and a software part. In other words, the term “U” control unit may mean any component and/or software capable of analysing the sound source.

Structurally, the pads 2 have a shape such as to substantially define a portion of geoid or a hemisphere. In particular, the pads 2 define a concave inner surface.

FIG. 2 shows a first embodiment of the pad.

Advantageously, the structure allows the pads 2 of the device 1 to adapt to the shape of the ear.

As illustrated in FIG. 3, there are further embodiments having a more complex geometry. According to these embodiments, each pad has a base portion or crown 2b, which is substantially planar, and a concave portion 2c, which is substantially shaped to match an ear.

Advantageously, thanks to this structure, the shape of the pads 2 is further optimised relative to the ears 2 of a possible user.

Each pad has a plurality of recesses 2a distributed according to a predetermined distribution on the relative inner surface.

The recesses 2a define sound reproduction points. In particular, each of the recesses 2a houses a loudspeaker 3 or a group of loudspeakers 3a.

A particular feature of the device 1, according to the invention, is the arrangement and the orientation of the loudspeakers 3.

More specifically, the geometry of the reproduction points is designed in such a way that the sound waves propagate in the best possible way.

In particular, the reproduction points are designed in such a way as to form a sound wave the normal of which is preferably at a right angle to a listening point of a user.

The expression “listening point”, according to the invention, is used to mean basically the hearing duct which leads to the respective eardrum.

Therefore, if the reproduction point comprises a single loudspeaker 3, the loudspeaker 3 is preferably oriented in such a way that its normal is at right angles to the listening point.

In the case of a group of loudspeakers 3a, on the other hand, the resultant of the normal of the loudspeakers 3 is preferably at a right angle to the listening point.

However, according to embodiments having a geometry of the pads 2 which is more complex in order to further improve the sound perception, as in the embodiment illustrated in FIG. 3, it is possible that only the listening points of the concave portion 2c have the relative normal at right angles to the listening point whilst the reproduction points positioned on the base portion or crown 2b have a different orientation.

Another particular feature, according to the invention, is the spatial distribution of the loudspeakers 3 of a same group of loudspeakers 3a.

Preferably, each group of loudspeakers 3a has a number of loudspeakers 3 of between two and five.

FIGS. 4a-4c illustrate different embodiments of the groups of loudspeakers 3.

In particular, FIG. 4a shows a group of loudspeakers 3a consisting of three loudspeakers 3.

FIG. 4b shows a group of loudspeakers 3a consisting of three loudspeakers 3 positioned according to a further embodiment different from the embodiment of FIG. 4a.

FIG. 4c shows a group of loudspeakers 3a consisting of four loudspeakers 3.

FIG. 4d shows a group of loudspeakers 3a consisting of two loudspeakers.

As shown in the accompanying drawings, each group of loudspeakers 3a is positioned on the surface of the respective recess 2a, which has a concave surface preferably forming a portion of sphere or geoid.

Thanks to this arrangement it is possible to obtain a propagation of the sound striking in the most possibly curved manner on the ear of the user.

This curvature will be optimised with the increase in the number of loudspeakers 3, as a function of the distance between the reproduction point and the listening point.

In other words, a group of loudspeakers 3a comprising a high number of loudspeakers 3 has the advantage of better defining the sound, thus obtaining an optimum sound output.

Each pad 2 may comprise a number of loudspeakers 3 of between 7 and 128.

The device 1 structured in this way brings considerable advantages.

The high number of loudspeakers 3 allows use of a plurality of loudspeakers 3 in order to reproduce a respective sound source “S”.

This reproduction will occur, as explained below, using the reproduction configurations, that is to say, the use of a loudspeaker or, preferably, a plurality of loudspeakers 3, adjacent to a reference loudspeaker 3 considered at right angles to the propagation of the sound source “S”, selected as a function of a plurality of parameters.

In other words, the large number of loudspeakers 3 will allow the selection of a reproduction configuration of the loudspeakers 3 (more specifically, their number and adequate arrangement) in order to give the respective sound source “S” to be reproduced optimum directionality.

Another advantage provided by the high number of loudspeakers 3 is the possibility of optimising the ILD and ITD and effects.

In short, it will be possible to faithfully reproduce, intermittently and through the reproduction configurations, the procession of a sound wave which in natural conditions would affect the body, and in particular the skull, of the user.

Advantageously, moreover, thanks to the large number of loudspeakers 3, the device 1 is able to simulate the equalisation which the ear naturally performs according to the angle of incidence of the sound wave, that is to say, the device 1 is able to correctly simulate the HRTF.

Thanks to the large number of loudspeakers 3 and the possibility of selecting specific reproduction configurations, it is possible to perform an optimum number of frequency cuts in order to obtain very high sound quality and, at the same time, precisely simulate the angle of incidence of the sound waves, thereby improving the perception of the sound direction.

An advantage deriving from the particular shape of the pads 2 is that of providing an optimum distance between reproduction points and listening points.

This distance, together with the arrangement and the orientation of the reproduction points, allows the user to naturally perform an equalisation of the sound waves reproduced by the loudspeakers 3.

In effect, the sound waves produced by the loudspeakers 3 have a path sufficient to propagate in the correct manner before reaching the respective listening points of the user.

Thus, the simulation of the HRTF, using the plurality of loudspeakers 3 provided with the device 1, and the shape of the pads 2 considerably improve the sound immersion of the user.

According to a particular use of the device 1, in particular in the applications which involve augmented reality and virtual reality, the device 1 may comprise an orientation device, not illustrated in the accompanying drawings, for identifying a physical direction of a user representing a virtual direction relative to the sound source “S” in such a way that the control unit “U” performs the analysis as a function of the virtual direction of the user.

The orientation device may comprise at least one gyroscope and/or at least one accelerometer.

Moreover, in order to be able to optimise the positioning of the headphones relative to the respective listening points of the user, the device 1 may comprise a positioning template.

In other words, thanks to the positioning template, the user can centre in an optimum manner the pad of the headphones relative to the corresponding ear.

The template is made of fabric or a similar material able to guarantee comfort for the user.

The invention also relates to a three-dimensional sound reproduction method.

This method is achieved preferably by means of a device 1 as described above and claimed below. In other words, the method described may be taken to mean a method for using the device 1 described above.

The following method can also be understood as a software routine capable of analysing the sound source “S” in such a way as to correctly reproduce the sound with the device 1 (which therefore represents the hardware in which the software is at least partly integrated).

The method comprises a first step of preparing a digital sound source “S” defined by a graphical motor or by a professional audio format. In other words, the term “device” is used to mean a coding by means of matrices or spherical coordinates of the digital sound source “S”.

The device 1 analyses the sound source “S” as a function of the virtual position and orientation parameters “O” of the device 1 relative to the digital sound source “S”.

In particular, the device 1 measures a distance “D” between a coordinate of the device 1 in a virtual environment “AV” and the point of origin of the sound source “S”.

Moreover, in this analysis, the device 1 takes into account the virtual orientation “O” of the device 1 in the virtual environment “AV” relative to the sound source “S”.

By means of this analysis, after obtaining the virtual orientation “O” and the distance “D” of the sound source “S” in the virtual environment “AV” with respect to the device 1, the control unit “U” determines the reference loudspeaker 3 between the plurality of loudspeakers 3 of the device 1 and, around the reference loudspeaker 3, a reproduction configuration of the loudspeakers 3 is selected.

The reference loudspeaker 3 is the loudspeaker 3 whose normal is at right angles to the propagation of the sound source “S”.

The selection of the reproduction configuration is performed by selecting one or more specific configurations from a plurality of recorded configurations relating to specific virtual position and orientation parameters of the device 1 relative to said digital sound source “S”.

In other words, once the coordinates of the sound source “S” in the virtual environment “AV” have been obtained, it is determined which loudspeaker 3 will be considered “central” for the reproduction and therefore for the construction of the reproduction configuration.

For reproducing a sound, these configurations also comprise a number of loudspeakers 3 less than the total number of loudspeakers 3 with which a device 1 equipped.

Therefore, according to the analysis of the sound source “S”, a configuration of loudspeakers 3 is chosen, adjacent to the reference loudspeaker 3, in order to reproduce in the best possible ways the sound source “S”.

Preferably, the configurations comprise a plurality of loudspeakers 3, adjacent to the reference loudspeaker 3.

According to a further embodiment, the configurations may comprise a single loudspeaker 3, coinciding with the reference loudspeaker 3.

Once the reproduction configuration of the loudspeakers 3 has been selected, the control unit “U”, again on the basis of the analysis performed, determines the ITD and the ILD.

The method may also comprise the use of the HRTF in order to further improve sound reproduction.

However, as already explained above, the distance of the reproduction points relative to the respective listening points is sufficient to guarantee an optimum propagation of the sound waves.

Once the various reproduction parameters have been determined, the sound source “S” is reproduced by means of the reproduction configuration.

In particular, the loudspeakers 3 in the reproduction configuration reproduce the sound source “S” as a function of the predetermined parameters.

In other words, the reproduction of the sound source “S” is performed with a intensity and a sequence of reproduction of specific loudspeakers 3 defined by the selected reproduction configuration.

Advantageously, the method described herein overcomes the drawbacks of the prior art allowing the reproduction of a sound source, guaranteeing optimum directionality and sound quality.

In particular, this aim is achieved by the possibility of selecting specific reproduction configurations where these configurations comprise a large number of loudspeakers 3.

Consequently, it is possible to faithfully reproduce the ways in which the human hearing apparatus perceives sounds coming from a surrounding environment.

1. A three-dimensional sound reproduction device, in particular headphones, comprising:
a pair of specular pads, having a shape such as to substantially form a portion of geoid or a hemisphere; each forming a concave inner surface having a plurality of recesses distributed according to a predetermined distribution;
a plurality of loudspeakers, designed for sound reproduction and housed in said recesses;
a control unit, connected to said plurality of loudspeakers, configured to perform an analysis of a digital sound source and to determine a sound reproduction configuration of the loudspeakers as a function of said analysis of the sound source.

2. The device according to claim 1, wherein each pad comprises a number of loudspeakers of between 7 and 128.

3. The device according to claim 1 or 2, wherein each of said recesses houses a loudspeaker or a group of loudspeakers; each group of loudspeakers comprising a number of loudspeakers of between 2 and 5.

4. The device according to claim 3, wherein said loudspeaker or group of loudspeakers are positioned in such a way as to form a sound wave the normal of which is orthogonal to a listening point of a user.

5. The device according to claim 1, comprising an orientation device for identifying a physical direction of a user representing a virtual direction relative to said sound source in such a way that said control unit performs said analysis as a function of the virtual direction of the user; said orientation device comprising at least one gyroscope and/or at least one accelerometer.

6. A three-dimensional sound reproduction method comprising the steps of:
preparing a digital sound source defined by a graphical motor or by a professional audio format;
preparing a device for the three-dimensional sound reproduction according to claim 1;
analysing said sound source as a function of the virtual position and orientation parameters of the device relative to said digital sound source;
selecting a reproduction configuration of the loudspeakers as a function of said analysis;
reproducing said sound source using said reproduction configuration.

7. The method according to claim 6, wherein said analysing step is performed by measuring a distance between a coordinate in a virtual environment of said device and a point of origin of the sound source.

8. The method according to claim 6, wherein said analysing step is performed taking into account a virtual orientation of the device in said virtual environment relative to said sound source.

9. The method according to claim 6, wherein said step of selecting the reproduction configuration is performed by selecting one or more specific configurations from a plurality of recorded configurations relating to specific virtual position and orientation parameters of the device relative to said digital sound source.

10. The method according to claim 6, wherein said step of reproducing the sound source is performed with an intensity and a reproduction sequence of specific loudspeakers defined by said selected reproduction configuration.
